(19) United States
(12) Patent Application Publication
(10) Pub. No.: US 2025/0065339 A1
(43) Pub. Date: Feb. 27, 2025

(54) Method for Increasing the Yield of Rounded Graphite Particles

(71) Applicant: NETZSCH Trockenmahltechnik GmbH, Hanau (DE)

(72) Inventors: Christian Höfels, Hanau (DE); Patrick Schöbel, Frankfurt am Main (DE); Frank Winter, Mühlheim am Main (DE)

(21) Appl. No.: 18/811,990

(22) Filed: Aug. 22, 2024

(30) Foreign Application Priority Data
Aug. 23, 2023 (DE) 10 2023 122 651.7

(51) Int. Cl. B02C 23/14; B02C 17/18; B02C 23/10

(52) U.S. Cl. CPC B02C 23/14; B02C 17/185; B02C 23/10

(57) ABSTRACT

A method for producing graphite particles of certain, different fineness classes rounded by impact effect, with the help of several spheroidal separators, which are connected in series, wherein the graphite material to be rounded is pre-comminuted, and from this, a first spheroidal separator then produces graphite material, which is spheroidized by means of folding, of a first fineness class, which is discharged from the method as end product, and simultaneously separates graphite material, which can predominantly not be processed to graphite material of this first fineness class because it is too comminuted, wherein the separated graphite material, which is too comminuted, is fed to a second spheroidal separator, which, from this, can produce graphite material, which is spheroidized by means of folding, of a second, finer fineness class, which is likewise discharged from the method as end product.

The invention relates to a method for rounding graphite particles, by means of which a higher yield of rounded graphite particles can be achieved, with smaller waste quantity.

This rounding is also referred to as spheroidization.

### TECHNICAL FIELD

Lithium-ion batteries are currently the state of affairs, where batteries are needed to drive electrical devices—from laptop and hand tools to automobiles.

It is prior art to equip lithium-ion batteries with an anode made of graphite. On the one hand, the graphite anode has the task of conducting and of supplying current to the outside, for the purpose of which graphite is best suited by nature. Li-ions furthermore flow to said graphite anode during each current drain from the battery cell via the electrolyte thereof, which it has to store in its grid structure.

In addition to the chemical purity, the morphology of the graphite plays an important role.

Spherical graphite (SPG) is ideal for the use as anode material. The smooth, significantly less anisotropic and thus universally receptive surface thereof is well able to interact effectively with the Li-ions to be stored in the anode material and to thus provide a high anode chargeability. Spherical graphite furthermore has less of a tendency to flake and the irreversible capacity loss associated therewith, so that a longer service life can be reached. As a whole, a higher energy density, paired with a longer service life can thus be achieved when using spherical graphite.

In nature, graphite occurs, for example, as so-called flake graphite distributed in rock, as it is shown in FIG. 1.

Untreated flake graphite with its layered morphology shows pronounced basal planes. These are the planes, which run parallel to the crystal structure of the graphite. Along these planes, graphite represents a very good thermal as well as electrical conductor, while graphite transversely to the basal planes—thus between the individual planes—can be considered to be a thermal as well as electrical insulator. Flake graphite thus displays a pronounced anisotropy.

For this reason, flake graphite has to be processed in order to produce the required spherical graphite therefrom. This is so because the basal problematic is largely foreign to said spherical graphite. It is thus much better suited for electrical uses. FIG. 2 gives the impression of what spheroidized graphite material of the fineness class SPG 20 looks like.

Other fineness classes, which are often in demand in practice, are the fineness classes SPG 22, 18 and 10. As the expert knows, reference is made to the fineness class SPG 20, e.g., when the d₅₀ of the material is 20 μm, thus when 50% of the particles making up the graphite material have a smaller equivalence diameter than 20 μm. Analogously the same applies for the other fineness classes.

The corresponding processing is known in the prior art even though it is still quite a new technology. It is referred to as spheroidization.

The spheroidization is not achieved, for instance, by means of grinding or cylindrical grinding of individual particles of the flake graphite but by means of multiple so-called folding of the graphite flakes. The folding is achieved in that graphite flakes carried by a carrier gas stream or process gas stream, respectively, are made to collide repeatedly with obstacles, with a kinetic energy, which is selected so that the graphite particles are not crushed, but only folded, thus deformed.

The cascading series connection of approx. 20 to 30 separator mills, to which an externally produced process gas stream is applied, is a common continuous process for the spheroidization of graphite. An additional separator, a filter and a fan are provided between two respective consecutive separator mills in the cascade. These separator mills run as follows during continuous operation:

The first separator mill in the cascade is continuously fed with untreated “raw graphite”, the graphite rounded in the desired grain size can only be removed from the last separator mill in the cascade, thus the useful material, i.e., the graphite material of the desired fineness class.

The desired rounding and fineness class is gradually approached by means of the individual separator mills.

If the initially still untreated graphite has been rounded extensively in the first separator mill, so that it falls below a certain size, it is inevitably discharged from said separator mill, together with the fine material, which inevitably develops during the rounding. It is then subjected to a further separation and filtering, in order to separate the fine material (thus particles, which are already too small to achieve the goal) and the reusable graphite material, which is to be subjected to a next rounding step. The fine material is discarded. The remaining graphite material is then supplied to the next separator mill in the cascade, which subjects it to the next rounding step and discharges it again, as soon as it has reached a certain smaller size.

Due to its deeply staggered cascading, this method is hard to control in practice by involving different system components. The discarded fine material accumulates as no longer usable mixture of a large variety of particle sizes.

An improved spheroidization method has recently been described by the Hosokawa Alpine, Augsburg, in the trade journal Carbon 201 (2023) 847-855.

For the purpose of a more efficient spheroidization, the following batch method is proposed:

The raw graphite is initially subjected to a real grinding process in a separator mill, in order to thus pre-comminuted it and to produce graphite flakes, which are small enough to be able to produce spherical graphite of the desired quality or fineness class, respectively, therefrom in a single subsequent spheroidization step. The graphite material pre-ground in this way is then introduced in portions into a now specific separator mill.

Said separator mill is provided with installations, which subject the graphite particles to a multiple folding and thus spheroidize them instead of crushing them unnecessarily. During operation, this separator mill internally generates a strong turbulent flow and, in our own words, can thus manage without an externally generated process gas stream. After a certain treatment time, the desired spheroidization degree has been reached. The specific separator mill is now unloaded. The graphite mixture obtained in this way is fed to a separator, which separates the finished, spherical graphite particles from the accompanying fine material, which is to be discarded.

This method can be controlled well and also promises a good throughput. Its disadvantage is that a significant quantity of the used raw graphite accumulates as fine material, which is too fragmented in order to be used further and is thus discarded.

### THE PROBLEM ON WHICH THE INVENTION IS BASED

The invention is based on the problem of specifying a method for the spheroidization, which is easy to control, and which simultaneously better utilizes the used graphite material, thus leaves behind less fine material to be discarded and provides a higher yield of useful material.

### THE SOLUTION ACCORDING TO THE INVENTION

According to the invention, this problem is solved by means of a spheroidization method according to claim 1.

It is a method for producing graphite particles, which are rounded by impact effect, of certain, different fineness classes by using uniformly pre-comminuted raw graphite.

Several spheroidal separators, which are connected in series, are used thereby.

The method starts with the graphite material, which is to be rounded, being pre-comminuted in such a way that it is suitable to produce the coarsest fineness class of the different fineness classes, which are to be produced by means of the method according to the invention.

The first spheroidal separator is then loaded with the pre-comminuted raw graphite. From this, it produces graphite material, which is spheroidized by means of folding, of a first fineness class. After the batch time, this graphite material is discharged directly from the first spheroidal separator as useful material, i.e., as end product, thus does not pass through a further spheroidal separator.

Still during the batch period, the first spheroidal separator separates fine material, which can predominantly not be processed to graphite material of this first fineness class and for the production of which it is responsible, via its separator wheel. This is so because the particles of this fine material are too fine. This graphite material, which constitutes the fine material, may partly already originate from the pre-grinding, but it partly also consists of a fracture, which was created in an undesired manner during the rounding in the first spheroidal separator.

The graphite material separated as fine material is fed to a second spheroidal separator, which, from this, can produce and does produce graphite material, which is spheroidized by means of folding, of a second, finer fineness class. Preferably, the graphite material of the second, finer fineness class is also directly centrifuged here from the second spheroidal separator as useful material, i.e., as end product, after the batch time. It then does not pass through a further spheroidal separator.

It is thus the fundamental solution concept of the method according to the invention to only use raw graphite, which was suitably pre-ground for the coarsest fineness class, for the production of spheroidized graphite of different fineness classes. To produce the suitable raw material for at least one finer fineness class, the fact is exploited that a certain further grinding is associated with the spheroidization of the graphite of the coarser fineness class, due to which fracture develops. Even though this fracture, which is too small, is no longer suitable for producing graphite of the coarser fineness class, it is very well suited, however, to be processed to graphite of a finer fineness class.

This is also not least due to the fact that a not only insignificant portion of the fracture, which constitutes the fine material, has already experienced a rounding in the first spheroidal separator, which then ended abruptly due to the fracture.

In light of these considerations, it becomes clear that the previous approach, namely of very strongly pre-grinding the raw graphite in order to be able to produce, e.g., graphite of the fine fineness class SPG 10 as useful material by means of rounding, instead of to first see, which coarser fineness class can initially be produced from this, is wasteful.

### OPTIONAL DESIGN POSSIBILITIES OF THE INVENTION

It has proven to be particularly favorable to not only have the first spheroidal separator in mind, which provides graphite material of the coarsest quality level, when determining how strongly to pre-comminute or pre-grind. Instead, it makes sense to set the intensity, with which pre-grinding or pre-comminuting takes place, so that more than 50% by weight of the graphite material placed onto the first spheroidal separator can be separated via the separator wheel thereof and can then be placed onto the second separator, which produces graphite material of a finer fineness class.

Another, particularly favorable design option is that the paddle surfaces of at least one spheroidal separator are enlarged in such a way that the quotient of the net volume of the separator chamber and of the paddle surface lies in the range of between 0.5 and 2.0. In some cases, a tolerance of +/−10% will be permissible here, the mentioned limits are preferably adhered to completely or at least essentially, however.

The total volume of the separator chamber minus the envelope volume of the separator wheel is understood thereby as net volume of the separator chamber.

The surface of the paddles, which forms an end face in the circumferential direction, on which the graphite particles impact and are thus folded, is understood to be the paddle surface.

The process of the spheroidizing can be accelerated in this way because more energy can be placed onto the material to be spheroidized, without having to increase the speed, thus increasing the impact intensity and thus increasing the portion of developing fine material.

It is another design option to decrease the separator wheel diameter to the extent that the quotient of the net volume (as just defined) of the separator chamber and the envelope volume of the separator wheel lies between 4.2 and 6.5. In some cases, a tolerance of +/−10% will be permissible thereby, the mentioned limits are preferably adhered to completely or at least essentially, however.

The space, in which the material to be spheroidized revolves, is enlarged thereby. This allows for a higher loading capacity and simultaneously increases the mobility of the material to be spheroidized in the separator space, which has a positive impact on the folding process and its yield.

### BRIEF DESCRIPTION OF DRAWINGS

FIG. 1 shows raw graphite, which is present as flake graphite.

FIG. 2 shows spheroidized graphite of the fineness class SPG 22.

FIG. 3 illustrates an important detail of a spheroidal separator, which is preferably used here.

FIG. 4 shows a comparative example corresponding the previous concept of the applicant for a method, which is not in accordance with the invention, in order to permit a yield comparison with the method according to the invention.

FIG. 5 shows a first exemplary embodiment of the invention.

FIG. 6 shows a second exemplary embodiment of the invention.

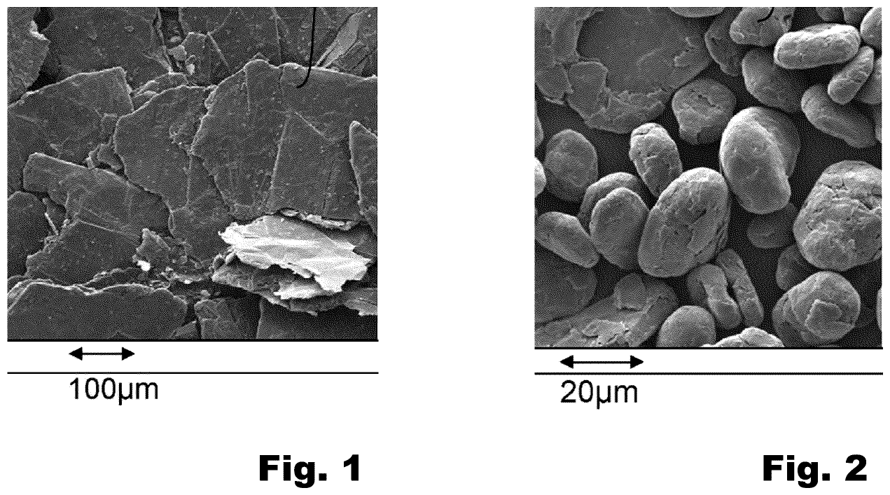

### MILLS AND SEPARATOR MILLS

A mill, which is connected upstream of the actual rounding process, is used to carry out the method according to the invention. The mill comminutes the raw graphite and mostly also homogenizes it—in the sense that the differences of the grain sizes, which can be encountered in the graphite particle mixture, which is to be spheroidized subsequently, are less pronounced.

In particular with regard to the latter, a separator mill is preferably used as upstream mill.

A separator mill in the sense mentioned here combines a mechanical impact mill with an integrated dynamic air separator.

Such a separator mill is characterized in that a separator wheel revolves in its separator chamber and a strong circular vortex is created in the separator chamber. The graphite particles to be ground are entrained by the circular vortex when entering into the separator chamber. They experience strong centrifugal forces thereby, which essentially keep the particles, which are still too large, in a range which is sufficiently radially spaced apart from the separator wheel in order to discharge these particles into the separator wheel, which receives flow, and to convey it out of the separator mill from there. During their turbulent run through the separator chambers, the graphite particles collide with the paddles and the impact surfaces and are crushed on them. Graphite particles, which have become sufficiently small by means of a one-time or repeated crushing, can no longer be kept away permanently from the separator wheel by means of the only still smaller centrifugal forces applied to them, but are discharged into the interior thereof by means of the flow and are then separated.

A separator mill, which is particularly well suited for this application, is, for example, the model CSM 900 by the applicant.

### SPHEROIDAL SEPARATOR

The rounding according to the invention is characterized in that the graphite particles are folded repeatedly and thus obtain their round shape. By nature, some fracture also occurs thereby. Fracture is not intended but can also not be avoided completely. You could say, however, that the graphite particles in particular do not obtain their rounded shape by means of a grinding process.

Together with other particles, which are too small and which possibly still originate from the pre-grinding, fracture is discharged via the interior of the separator wheel and forms the so-called fine material. This fine material is characterized in that it is too small to still produce graphite material of the fineness class, which is currently being rounded in the respective spheroidal separator, from this.

With regard to their general setup, the spheroidal separators, which are used according to the invention, are separator mills, but are used in a modified manner and/or so as to be operated in a modified manner. A significant modification is that a spheroidal separator operates with a process gas stream, which is decreased compared to a separator mill. The process gas stream of a spheroidal separator usually lies at 30% by volume to 10% by volume of the process gas stream of a separator mill with an essentially identical construction.

Ideally, such a spheroidal separator is essentially constructed in the way as it is described in the DE 10 2020 100 907 A1 of today's applicant, which is hereby made the subject matter of this application.

It is in accordance with the invention, however, to preferably make use of the spheroidal separators described by the mentioned patent application in structurally modified form—in the manner as it will be described in more detail below.

It is important that the kinetic energy, with which the graphite particles revolve in the separator chamber of the spheroidal separator, is reduced compared to the separator mill operation to the extent that the graphite particles revolving in the separator chamber are predominantly only folded and are predominantly not further crushed by means of the collisions, which still take place, with the installed paddles and impact surfaces.

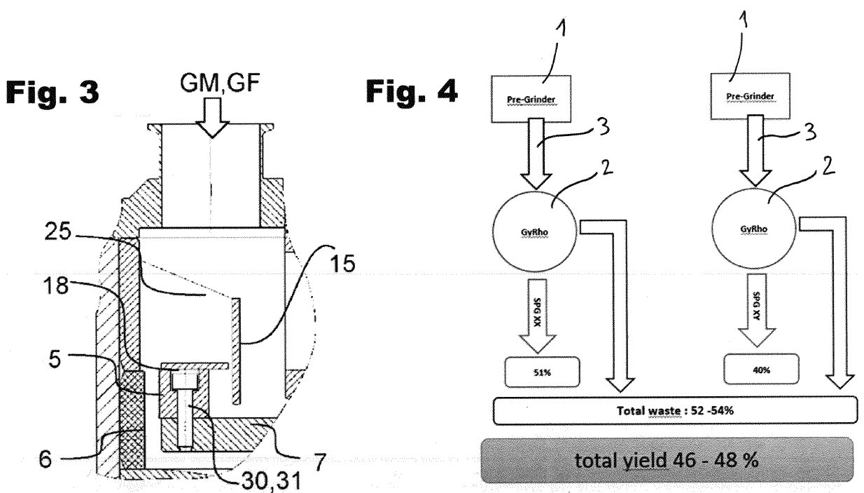

In order to nonetheless get to a folding of the graphite particles, which is as effective as possible, it has proven to be particularly advantageous to enlarge the height of the paddles 5, which can be seen well in FIG. 3 (corresponds to FIG. 3B of the DE 10 2020 100 907) in order to carry out the method according to the invention. Compared to the separator mills and the DE 10 2020 100 907 derived therefrom, the impact surface becomes larger thereby. The surface, which is available for a frontal impact, thus increases; when the respective paddle 5 revolves in the separator chamber, held by the screw 30, and collides with the graphite particles thereby.

Ideally, the height of the paddles, which, depending on the type, lies between 10 mm and 100 mm in the case of separator mills and the DE 10 2020 100 907, is enlarged by 75% to 110% in the case of the spheroidal separator according to the invention.

Preferably, more than 45% of the height of the paddles then lies at the height of the vertical gap of the separator wheel, through which the fine material is discharged, viewed in the radial direction.

The height of the impact surface 6 is optionally adapted accordingly.

The enlargement of the paddle surface has the result that more graphite particles per time unit experience an impact, which rounds them again a little further. More energy per time unit can thus be applied, without making the individual impact more aggressive and causing even more unwanted fraction. A faster rounding is achieved thereby. In the batch operation, the processing time per batch thus decreases.

It has furthermore proven to be favorable to leave out the cover ring 18, which is not least shown in large representation by FIG. 3B of the DE 10 2020 100 907 A1.

### FIRST CONCRETE EXEMPLARY EMBODIMENT AND COMPARATIVE EXAMPLE

FIG. 3 shows the spheroidization method, as it has been practiced until now by using the spheroidal separators known from DE 10 2020 100 907 A1 of the applicant herein and as it has also already been propagated in presumably more or less similar form by the Hosokawa Alpine according to the above descriptions (which are the findings of in-house tests with regard to the topic).

Commercially available spheroidized graphite material (SPG) of a certain quality class is produced on a separate system, which is adjusted specifically for this purpose.

If, for example, graphite material of the fineness classes SPG 20 and SPG 10 is to be produced, this takes place on two systems, which are configured and operated completely independently of one another, as they are shown in FIG. 4.

In order to produce graphite material of the fineness class SPG 10, raw graphite is pre-ground by means of a separator mill 1, for instance a Netzsch CSM 900, to a d₅₀=10 μm so that the graphite particles are sufficiently small in order to be able to produce graphite material of the fineness class SPG 10 from this by means of mere folding with the help of one of the mentioned spheroidal separators 2.

For this purpose, the pre-ground raw graphite 3 is placed onto the spheroidal separator 2 in batches. It revolves in the separator chamber for a predetermined time, which is allotted so that the graphite particles still located in the separator chamber are rounded at the end of the running time so that they meet the requirements of the quality SPG 10. During the revolution, fine material (thus particles, which are too small for SPG 10) is permanently removed and discharged in the above-described manner via the separator wheel.

The same process is used—completely independently thereof—on the second line, on which graphite material of the fineness class SPG 20 is produced.

When using 1.233 kg/h of raw graphite, this leads to a yield of 661 kg/h, thus a total yield of 46.4%.

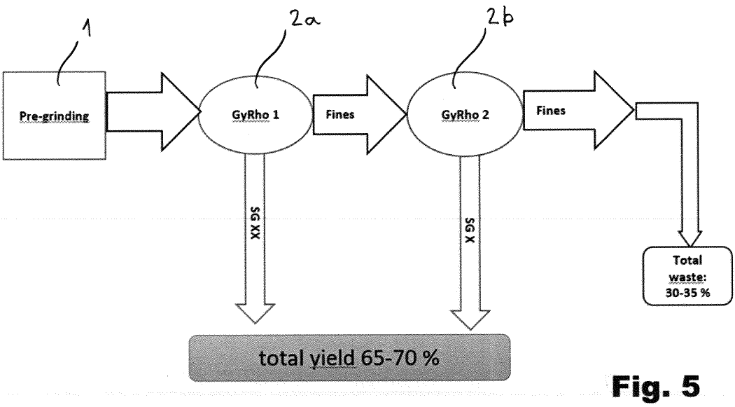

The process according to the invention is different, namely as shown in FIG. 5.

### FIG. 5

A system of an upstream separator mill and a spheroidal separator, which is mostly connected directly downstream therefrom, and downstream of which a second spheroidal separator is connected, in turn, is used. The two spheroidal separators are preferably identical or of identical construction, respectively, but are operated with different fineness indicator (other operating parameters→speed, gas quantity; other separator wheel). As a rule, the spheroidal separators are of identical construction and are operated identically, unless otherwise specified in the statements made below.

Ideally, spheroidal separators, which are constructed in the manner as described by DE 10 2020 100 907, are used for the realization of the invention—and thus also for this exemplary embodiment. Ideally, these spheroidal separators are additionally provided with at least one of the modifications described above for the DE 10 2020 100 907.

The raw graphite is likewise pre-ground here.

In the case of this variation of the invention, however, a pre-grinding at least essentially takes place only to the particle size, which the finished, spheroidized graphite of the coarsest fineness class to be produced by means of this system is to have, because a noteworthy reduction of the d₅₀ of the usable particles usually does not occur as part of the spheroidization, as long as no fraction occurs.

In the present case, a pre-grinding essentially to a particle size of d₅₀=20 μm thus takes place when the first useful product is to be spheroidized graphite with this d₅₀. A pre-grinding does not take place, which comminutes so strongly that graphite material of a finer fineness class than that graphite, which is produced in the first spheroidal separator, could be rounded directly solely by means of one of the spheroidal separators used here.

A separator mill 1, ideally likewise with a Netzsch CSM 900, is used for the pre-grinding.

According to the invention, several spheroidal separators 2a, 2b are arranged downstream from a separator mill 1, as already mentioned. A first upstream spheroidal separator 2a is fed with pre-ground raw graphite, matching the fineness class to be produced by it (e.g., raw material with a d₅₀ of 20 μm for SPG 20), namely preferably in batches.

It is also the case here that the placed graphite revolves in the separator chamber for a predetermined time, which is allotted so that the graphite particles still located in the separator chamber are rounded at the end of the running time so that they meet the requirements of the desired quality, so that graphite material of the fineness class SPG 20 is thus produced here.

It can be an sensible option to embody the separator wheel of the first spheroidal separator with a diameter, which is 15% to 25% smaller than the separator wheel of the second, otherwise mostly (at least essentially) structurally identical spheroidal separator.

It is particularly preferred when the first spheroidal separator (more precisely: its paddles) is operated with a speed, which varies during each batch processing or which is reduced in the course of a batch processing, starting at 100% of the initial speed at the beginning of the batch processing, to a speed of 70% to 40% thereof, respectively. It can be controlled thereby that, on the one hand, the first spheroidal separator does in fact produce graphite material of the desired fineness class. It can simultaneously or alternatively be controlled thereby that the first spheroidal separator does in fact output fine material of a type and/or quantity, with which the second spheroidal separator can do something via the interior of its separator wheel.

Fine material (thus in this example particles, which are too small for SPG 20) is permanently removed in the above-described manner during the revolution. This fine material mostly consists of particles, which were already too small after the pre-grinding, and those particles, which got broken during the spheroidization in this first spheroidal separator and thus became too small.

According to the invention, the fine material is not discarded but is placed directly or via a silo intermediate storage onto a downstream spheroidal separator 2b. This spheroidal separator 2b subjects the placed material to the already described rounding by means of folding once again and thus produces graphite material of a finer fineness class, ideally of a fineness class, which lies several, ideally at least 5 full μm fineness levels below the last previously produced fineness class, here, for instance, graphite material of the fineness class SPG 10. Fine material developing thereby is removed via the separator wheel again.

However, it is preferred that the second spheroidal separator (or its paddles, respectively), in contrast to the first spheroidal separator, is operated at 100% speed during the entire batch processing. It can be sensible thereby, however, that the gas quantity flowing through the second spheroidal separator, compared to the gas quantity flowing through the first spheroidal separator, is reduced by 10% by volume to 40% by volume.

At the end, the graphite material with the respective desired fineness is in each case removed from the separator space of the respective spheroidal separator, e.g., in the manner as is described by the DE 10 2020 100 907.

In order to be able to precisely control the process, only two spheroidal separators are advantageously connected in series in the described manner. In order to be able to process higher masses, several such systems according to the invention are typically connected in parallel.

The yield is significantly higher. When using 960 kg/h of raw graphite, 435 kg/h of graphite material of the fineness class SPG 20 and 167 kg/h of graphite material of the fineness class SPG 10 is obtained. This corresponds to a total yield of 62.8%.

### SECOND CONCRETE EXEMPLARY EMBODIMENT

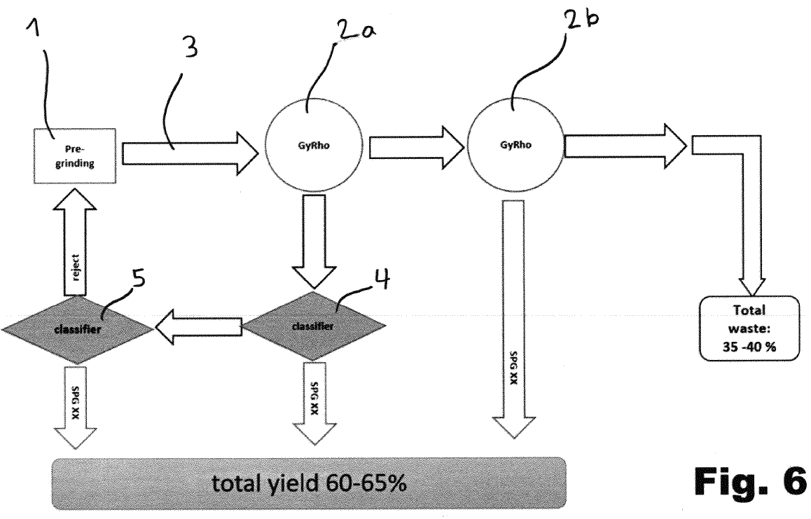

The second exemplary embodiment according to the invention is shown by FIG. 6. Except for the differences identified below, the setup corresponds to the above-described first exemplary embodiment. The statements made there thus also apply accordingly here, unless otherwise specified from the below-mentioned differences.

### FIG. 6

A difference is here that only coarser pre-comminuted raw graphite is applied to the first spheroidal separator 2a. In order to produce spheroidized graphite of a certain, coarsest fineness class d₅₀ by means of this system on the first spheroidal separator, the d₅₀ of the pre-comminuted raw graphite is preferably set to be 10% to 30% higher than the respective fineness class. If, as in this exemplary embodiment, graphite of the fineness class SPG 22 is to thus be produced, a pre-comminution to a d₅₀ of approximately 24 μm to approximately 28 μm takes place. This results in a higher throughput in the pre-grinding and a wider grain size distribution.

The first spheroidal separator is then operated so that it produces a mixture of two fineness classes, e.g., graphite material of the fineness classes SPG 18 and SPG 22, as product.

A further special feature in the case of this exemplary embodiment can be that the separator wheel of the first spheroidal separator 2a is embodied with a smaller diameter than the separator wheel of the downstream spheroidal separator 2b. In most cases, it revolves at a higher speed than the separator wheel of the downstream spheroidal separator.

This has the result that the separator space of the first spheroidal separator 2a can absorb an enlarged batch (in terms of mass) of pre-comminuted graphite and can subject it to a rounding.

In the case of this exemplary embodiment, it is also particularly preferred when the first spheroidal separator 2a (more precisely: its paddles) is operated with a speed, which varies during each batch processing, this results in the above-mentioned advantages.

The described modification of the separator wheel of the first spheroidal separator 2a has the result that the separation limit thereof decreases. However, due to the additionally provided separators 4 and 5 here (more on this at once), this does not play a role. They compensate for this “disadvantage”—which makes it possible to produce usable graphite material of different fineness classes, e.g., of the fineness classes SPG 18 and SPG 22, in the first spheroidal separator 2a by ideally utilizing the placed raw graphite pre-comminuted to a lesser extent.

This product is discharged directly downstream from the first spheroidal separator 2a. In order to obtain the useful or end product from this, respectively, the product is still further treated. A first additional, separate separator 4 is used for this purpose. The separator now separates essentially the rounded graphite particles, which belong to the fineness class SPG 18, from the product. A portion of the useful or end product, respectively, is thus graphite material of the fineness class 18.

The remainder of coarser graphite material resulting from the separation, which has just been described, is fed to a further, separate separator. It is thus separated once again—namely into a batch of graphite material, which is so coarse that it can be fed to the pre-comminution or pre-grinding once again, and into a second batch, which forms a second useful or end product, respectively, namely graphite material of the fineness class SPG 22.

The fine material, which is removed via the interior of the separator wheel of the first spheroidal separator 2a, is not discarded. Instead, it is further processed in the manner, which has already been described for the first exemplary embodiment, by a second spheroidal separator 2b, in graphite material of a further, finer fineness class, which, as already identified above, often lies several fineness levels below the last previously produced fineness class—here, for example, to graphite material of the fineness class SPG 10.

In order to be able to precisely control the process, only two spheroidal separators are also connected in series in the described manner in the case of this exemplary embodiment. In order to be able to process higher masses, several such systems according to the invention are typically connected in parallel.

A significant increase of the yield also results in the case of this method:

When using 894 kg/h of raw graphite, 137 kh/h of graphite material of the fineness class SPG 22, 228 kg/h of graphite material of the fineness class SPG 18 as well as 167 kg/h of graphite material of the fineness class SPG 10 is obtained. This corresponds to a total yield of 60%.

1. A method for producing graphite particles of certain, different fineness classes rounded by impact effect,
with the help of several spheroidal separators, which are connected in series,
characterized in that
the graphite material to be rounded is pre-comminuted,
and from this, a first spheroidal separator then produces graphite material, which is spheroidized by means of folding, of a first fineness class, which is discharged from the method as end product,
and simultaneously separates graphite material, which can predominantly not be processed to graphite material of this first fineness class because it is too comminuted,
wherein the separated graphite material, which is too comminuted, is fed to a second spheroidal separator, which, from this, can produce graphite material, which is spheroidized by means of folding, of a second, finer fineness class, which is likewise discharged from the method as end product.

2. The method for producing graphite particles of certain, different fineness classes rounded by impact effect according to claim 1, characterized in that the intensity, with which pre-grinding or pre-comminuting takes place, is set so that more than 50% by weight of the graphite material placed onto the first spheroidal separator are separated via the separator wheel thereof and can then be placed onto the second separator, which produces graphite material of a finer fineness class.

3. The method for producing graphite particles of certain, different fineness classes rounded by impact effect according to claim 1, characterized in that two spheroidal separators are connected in series, each of which produces an end product.

4. The method for producing graphite particles of certain, different fineness classes rounded by impact effect according to claim 1, characterized in that the fine material, which is separated by the first spheroidal separator, is placed onto the second spheroidal separator, without separating and/or filtering it once again outside of the first spheroidal separator.

5. The method for producing graphite particles of certain, different fineness classes rounded by impact effect according to claim 1, characterized in that the product, which the second spheroidal separator downstream in the processing chain produces by means of rounding, is a graphite material, which is finer by several fineness classes than the graphite material of the product, which the first spheroidal separator produces by means of rounding.

6. The method for producing graphite particles of certain, different fineness classes rounded by impact effect according to claim 1, characterized in that the separator wheel speed of the first spheroidal separator can be variably controlled in the processing chain during a batch processing, while the separator wheel speed of the downstream second spheroidal separator is preferably kept constant throughout a batch processing.

7. The method for producing graphite particles of certain, different fineness classes rounded by impact effect according to claim 1, characterized in that the separator wheel diameter of the fist spheroidal separator is smaller than the separator wheel diameter of the second spheroidal separator downstream in the processing chain and/or that the separator wheel of the first spheroidal separator revolves faster than the separator wheel of the second spheroidal separator downstream therefrom in the processing chain.

8. The method for producing graphite particles of certain, different fineness classes rounded by impact effect according to claim 1, characterized in that the first spheroidal separator of the pre-comminuted raw graphite is acted on, the d50 of which is set to be 10% to 30% higher than the d50 of the coarsest fineness class, which the first spheroidal separator is to produce as product.

9. The method for producing graphite particles of certain, different fineness classes rounded by impact effect according to claim 1, characterized in that the first spheroidal separator is operated so that its target product can be divided into two ready-to-use graphite quantities, which consist of graphite material of different fineness degrees, ideally SPG 18 and SPG 22.

10. The method for producing graphite particles of certain, different fineness classes rounded by impact effect according to claim 1, characterized in that the first spheroidal separator is operated so that in addition to graphite material of the fineness class to be produced, its product also includes graphite particles, which are separated via an additional separator and which are then placed onto the pre-comminution once again, for further comminution and placement onto the first spheroidal separator again.

11. The method for producing graphite particles of certain, different fineness classes rounded by impact effect according to claim 1, characterized in that the separator wheel speed of the first spheroidal separator can be variably controlled in the processing chain during a batch processing, while the separator wheel speed of the downstream second spheroidal separator is preferably kept constant throughout a batch processing.

12. The method for producing graphite particles of certain, different fineness classes rounded by impact effect according to claim 1, characterized in that at least one, preferably two spheroidal separators are used, the paddle surfaces of which are enlarged in such a way that the quotient of the net volume of the separator chamber and of the paddle surface lies in the range of between 0.5 and 2.0.

13. A method for producing graphite particles of certain, different fineness classes rounded by impact effect with the help of several spheroidal separators, which are connected in series, wherein
the graphite material to be rounded is pre-comminuted,
and from this, a first spheroidal separator then produces graphite material, which is spheroidized by means of folding, of a first fineness class, which is discharged from the method as end product,
and simultaneously separates graphite material, which can predominantly not be processed to graphite material of this first fineness class because it is too comminuted,
wherein the separated graphite material, which is too comminuted, is fed to a second spheroidal separator, which, from this, can produce graphite material, which is spheroidized by means of folding, of a second, finer fineness class, which is likewise discharged from the method as end product and characterized in that the quotient of the net volume of the separator chamber and the envelope volume of the separator wheel lies between 4.2 and 6.5.

14. A device of several spheroidal separators for producing graphite particles of certain, different fineness classes rounded by impact effect,
with the help of several spheroidal separators, which are connected in series,
wherein
the graphite material to be rounded is pre-comminuted,
and from this, a first spheroidal separator then produces graphite material, which is spheroidized by means of folding, of a first fineness class, which is discharged from the method as end product,
and simultaneously separates graphite material, which can predominantly not be processed to graphite material of this first fineness class because it is too comminuted,
wherein the separated graphite material, which is too comminuted, is fed to a second spheroidal separator, which, from this, can produce graphite material, which is spheroidized by means of folding, of a second, finer fineness class, which is likewise discharged from the method as end product.

15. The method for producing graphite particles of certain, different fineness classes rounded by impact effect according to claim 2, characterized in that the fine material, which is separated by the first spheroidal separator, is placed onto the second spheroidal separator, without separating and/or filtering it once again outside of the first spheroidal separator.

16. The method for producing graphite particles of certain, different fineness classes rounded by impact effect according to claim 2, characterized in that the product, which the second spheroidal separator downstream in the processing chain produces by means of rounding, is a graphite material, which is finer by several fineness classes than the graphite material of the product, which the first spheroidal separator produces by means of rounding.

17. The method for producing graphite particles of certain, different fineness classes rounded by impact effect according to claim 2, characterized in that the separator wheel speed of the first spheroidal separator can be variably controlled in the processing chain during a batch processing, while the separator wheel speed of the downstream second spheroidal separator is preferably kept constant throughout a batch processing.

18. The method for producing graphite particles of certain, different fineness classes rounded by impact effect according to claim 2, characterized in that the separator wheel diameter of the fist spheroidal separator is smaller than the separator wheel diameter of the second spheroidal separator downstream in the processing chain and/or that the separator wheel of the first spheroidal separator revolves faster than the separator wheel of the second spheroidal separator downstream therefrom in the processing chain.

19. The method for producing graphite particles of certain, different fineness classes rounded by impact effect according to claim 2, characterized in that the first spheroidal separator of the pre-comminuted raw graphite is acted on, the d50 of which is set to be 10% to 30% higher than the d50 of the coarsest fineness class, which the first spheroidal separator is to produce as product.

20. The method for producing graphite particles of certain, different fineness classes rounded by impact effect according to claim 2, characterized in that the first spheroidal separator is operated so that its target product can be divided into two ready-to-use graphite quantities, which consist of graphite material of different fineness degrees, ideally SPG 18 and SPG 22.
